(19) United States
(12) Patent Application Publication
(10) Pub. No.: US 2019/0018749 A1
(43) Pub. Date: Jan. 17, 2019

(54) DATA PROCESSING DEVICE, DATA PROCESSING METHOD, AND PROGRAM RECORDING MEDIUM

(71) Applicant: NEC Corporation, Minato-ku, Tokyo (JP)

(72) Inventors: Fumio MACHIDA, Tokyo (JP); Seiichi KOIZUMI, Tokyo (JP); Masaya FUJIWAKA, Tokyo (JP); Daichi KIMURA, Tokyo (JP)

(73) Assignee: NEC Corporation, Minato-ku, Tokyo (JP)

(21) Appl. No.: 15/750,626

(22) PCT Filed: Aug. 22, 2016
(86) PCT No.: PCT/JP2016/003799

§ 371 Date: Feb. 6, 2018

(30) Foreign Application Priority Data
Aug. 27, 2015 (JP) 2015-167943

(51) Int. Cl. G06F 11/34; G06Q 50/26; G06Q 10/06; G06F 17/30

(52) U.S. Cl. CPC G06F 11/3447; G06Q 50/26; G06F 17/30395; G06F 17/30737; G06Q 10/06393

(57) ABSTRACT

Provided is a data processing apparatus including a guide-word extraction unit that extracts, based on a name of a first node that is a node included in a social system model, at least one guide-word corresponding to the first node from a guide-word storage that stores correspondence between a name of a node and a guide-word; a guide-word selection unit that accepts selection input for at least one extracted guide-word; a performance indicator extraction unit that extracts, from a performance indicator storage that stores correspondence between a guide-word and at least one performance indicator regarding an information communication system, at least one performance indicator corresponding to a selected guide-word; a performance indicator selection unit that accepts selection input for at least one extracted performance indicator; and a model update unit that associates, as a second node, a selected performance indicator with the first node.

### TECHNICAL FIELD

The present invention relates to a data processing method for synthesizing a system model, and specifically relates to a data processing method capable of acquiring a model that captures a mutually dependent relation between a social system and an information system.

### BACKGROUND ART

In order to solve various social problems such as ensuring safety of cities, relief of traffic congestion, effective use of resources, and measures against natural disasters, an information communication technology is used. An information system is used to monitor a situation of a society by using a wide variety of sensors and cameras, analyze collected data, and appropriately understand a situation of the real world. Control that causes a change in the real world has been made possible through a notification to a security guard and a monitoring person, information display on a display and the like, and an operation of a robot or a machine. In order to solve a social problem by using such various functions of an information system, it is important to appropriately understand a problem structure of a society, and an effect and an influence produced by a function of an information communication system and make use of these matters in control design.

In order to understand a structure of a complex social problem, a cause-and-effect relation diagram and system dynamics are used in a field of social science. The cause-and-effect relation diagram describes a relation between attribute values that change in a society, by using a graph structure, and thereby enables analyzing a cause-and-effect relation thereof and a feedback structure. Further, the system dynamics introduce a stock and flow concept into a cause-and-effect relation diagram, and thereby enable analyzing a temporal change of a variable based on a cause-and-effect relation. In recent years, such modeling techniques are used as a tool for considering a solving means for a social problem. One example of a technique for efficiently acquiring an appropriate social model that provides a problem solution is disclosed in, for example, PTL 1.

PTL 1 discloses a technique for presenting a screen that defines a cause and effect by using a node and a link, assigning, for each registered phenomenon and event, metrics information and the like quantitatively representing amounts of these extents, and thereby creating a simulation model based on system dynamics.

On the other hand, in order to solve and relieve a social problem by an information communication system, it is necessary to provide a function provided by the information communication system with expected quality. The quality of the information communication system includes performance, reliability, cost, and the like. These qualities are determined depending on a computer resource for executing information processing, a network resource upon performing communication, and configurations thereof. Conventionally, in order to design quality of an information communication system, various modeling techniques have been used. For example, a queuing model enables analyzing a mean processing time and a processing rejection rate when a plurality of computer servers execute load balancing processing. Further, when a fault tree model is used, reliability of a system having a redundant configuration can be analyzed. When a model that evaluates quality of such an information communication system and a social model can be combined, it is possible to analyze an influence produced on a society by a configuration and an operation of the information communication system, and this matter thereby can be used in design and an operation of an optimum information communication system intended to solve a social problem.

However, it is not easy to combine a model for estimating performance of an information communication system and a model of a social system. The reason is that, firstly, notational systems and terms used in these models are basically different. In a model of a social system and a model of an information communication system, modeling purposes and targets are different, and therefore notational systems and terms generally used are also different. A model is a conceptual structure in which one side of a real event is abstracted and captured, and this capturing manner depends on a notational system and a term. A model of a social system is intended to capture a cause-and-effect relation of various inter-element relations in a society. In contrast, a model of an information communication system is intended to capture in detail structures of an information processing apparatus and a communication network and perform quality evaluation. Therefore, terms and notational systems used in these models are different. Secondly, it is problematic that detail degrees of elements to be modeled are different. In a model of a social system, modeling is performed using a concept having a high abstraction degree in order to capture a social structure from a global viewpoint. In contrast, in an information communication system, a model having as high detail degree and high general versatility as possible is used to perform strict quality evaluation. Therefore, in order to cause a detail degree to fit in any one of the models, reconsideration is needed from a point of view of a purpose of the model, and it is necessary to reperform modeling. In particular, when a structure of a society is intended to be modeled with a detail degree similar to that of an information system, all of various factors need to be considered, and therefore it is difficult to perform modeling.

As a modeling technique for analyzing an influence of performance of an information communication system on an operation and a service, or an indicator of business, a technique described in PTL 2 is known. PTL 2 discloses a technique for associating an evaluation indicator of an IT service with a measurement result thereof and a role operation of a person involved in work and generating a service structure. However, such a structuring technique needs a measurement result of an indicator and a log of operations, and therefore is difficult to apply to use of synthesizing a model for a system to solve a problem having not become reality yet.

Further, following PTL 3 discloses a technique for selecting a node and a link in a network structure including a plurality of nodes each representing event information and a link that defines a cause-and-effect relation between nodes, and adding and deleting a node and a link or changing an attribute. Further, PTL 4 discloses a technique for using information input by a past operation as input in another scene and thereby reducing time and effort spent for input by a user. Further, following PTL 5 and PTL 6 disclose a technique for analyzing a searched document, extracting a reputation word, generating a reputation pair in which the post-reputation and an object are combined, and also calculating a score indicating a degree of reputation and displaying summary information of each document by being ranked depending on the calculated score. Furthermore, following PTL 6 discloses a technique for calculating a score by using a predetermined calculation equation for each of candidates of a location corresponding to an input address expression and determining a location among the candidates, based on the score. Further, following PTL 7 discloses a technique for searching an entry word adapted to a predetermined word from a predetermined synonym dictionary and listing a synonym corresponding the searched entry word.

### CITATION LIST

### Patent Literature

PTL 1: Japanese Registered Patent Publication No. 4770495

PTL 2: Japanese Registered Patent Publication No. 5365008

PTL 3: Japanese Laid-open Patent Publication No. H06-044074

PTL 4: Japanese Laid-open Patent Publication No. 2011-239205

PTL 5: Japanese Laid-open Patent Publication No. 2008-234090

PTL 6: Japanese Laid-open Patent Publication No. 2008-090334

PTL 7: Japanese Laid-open Patent Publication No. 2005-293113

### SUMMARY OF INVENTION

### Technical Problem

A first problem is that it is difficult to combine a social system model for solving a social problem and a model of an information communication system being used as a solving means. The reason is that in both, terms and notational systems used in the respective models and detail degrees of modeling are different.

### OBJECT OF INVENTION

An object of the present invention is to provide a technique for associating a social system model for solving a social problem and a model of an information communication system being used as a solving means as described above.

### Solution to Problem

According to the present invention, a data processing apparatus is provided. The data processing apparatus includes: guide-word extraction means for extracting, based on a name of a first node that is a node included in a social system model, at least one guide-word corresponding to the first node from guide-word storage means for storing correspondence between a name of a node and a guide-word; guide-word selection means for accepting selection input for at least one extracted guide-word; performance indicator extraction means for extracting, from performance indicator storage means for storing correspondence between a guide-word and at least one performance indicator regarding an information communication system, at least one performance indicator corresponding to a selected guide-word; performance indicator selection means for accepting selection input for at least one extracted performance indicator; and model update means for associating, as a second node, a selected performance indicator with the first node.

According to the present invention, a data processing method for a computer is provided. The data processing method for a computer causes a computer to execute processing of: extracting, based on a name of a first node that is a node included in a social system model, at least one guide-word corresponding to the first node from guide-word storage means for storing correspondence between a name of a node and a guide-word; accepting selection input for at least one extracted guide-word; extracting, from performance indicator storage means for storing correspondence between a guide-word and at least one performance indicator regarding an information communication system, at least one performance indicator corresponding to a selected guide-word; accepting selection input for at least one extracted performance indicator; and associating, as a second node, a selected performance indicator with the first node.

According to the present invention, a computer-readable storage medium recording a program is provided. The computer-readable storage medium stores the program that causes a computer to function as: guide-word extraction means for extracting, based on a name of a first node that is a node included in a social system model, at least one guide-word corresponding to the first node from guide-word storage means for storing correspondence between a name of a node and a guide-word; guide-word selection means for accepting selection input for at least one extracted guide-word; performance indicator extraction means for extracting, from performance indicator storage means for storing correspondence between a guide-word and at least one performance indicator regarding an information communication system, at least one performance indicator corresponding to a selected guide-word; performance indicator selection means for accepting selection input for at least one extracted performance indicator; and model update means for associating, as a second node, a selected performance indicator with the first node.

### Advantageous Effects of Invention

An advantageous effect of the present invention is that it is possible to combine a social system model for solving a social problem and a model of an information communication system used as a solving means. The reason is that it is possible that, a name of a specific performance indicator used in a model of an information communication system is identified using a guide-word representing a category of a performance indicator, and thereby a node that is a connection point between a social system model and the information communication system is generated and the model of the information communication system is incorporated in the social system model.

### BRIEF DESCRIPTION OF DRAWINGS

FIG. 1 is a diagram conceptually illustrating a configuration of a data processing apparatus of a first example embodiment of the present invention.

FIG. 2 is a flowchart illustrating a flow of processing of the data processing apparatus of the first example embodiment.

FIG. 3 is a diagram illustrating one example of a social system model as input.

FIG. 4 is a diagram illustrating one example of information stored by a guide-word storage unit.

FIG. 5 is a diagram illustrating one example of a screen displayed when a node of a social system model is selected.

FIG. 6 is a diagram illustrating one example of a screen displayed when a node of a social system model is selected.

FIG. 7 is a diagram illustrating one example of information stored by a performance indicator storage unit.

FIG. 8 is a diagram illustrating one example of a screen that displays a performance indicator acquired by a performance indicator extraction unit.

FIG. 9 is a diagram illustrating one example of a result of processing executed by a model update unit.

FIG. 10 is a diagram conceptually illustrating a processing configuration of a data processing apparatus of a second example embodiment of the present invention.

FIG. 11 is a diagram illustrating one example of information stored by a synonym dictionary storage unit.

FIG. 12 is a diagram illustrating one example of information stored by an associated node information storage unit.

FIG. 13 is a diagram conceptually illustrating a processing configuration of a data processing apparatus of a third example embodiment of the present invention.

FIG. 14 is a diagram illustrating one example of information stored on a guide-word history storage unit.

FIG. 15 is a diagram illustrating one example of information stored on a performance indicator history storage unit.

FIG. 16 is a diagram conceptually illustrating a processing configuration of a data processing apparatus of a fourth example embodiment.

FIG. 17 is a diagram illustrating a cause-and-effect relation diagram in which a cause-and-effect relation between a safety management problem of a facility and value provision of a suspicious behavior and person identification function by a security camera is modeled.

FIG. 18 is a diagram illustrating an example in which a mark and a guide-word are additionally written in the cause-and-effect relation diagram of FIG. 17.

FIG. 19 is a diagram exemplarily illustrating a configuration of an information communication system of example 1.

FIG. 20 is a diagram illustrating an example of a queuing model including “c” processing servers and a buffer area of a size K.

FIG. 21 is a diagram illustrating one example of information stored by a performance indicator storage unit of example 1.

FIG. 22 is a diagram exemplarily illustrating a final output of example 1.

FIG. 23 is a diagram illustrating a cause-and-effect relation diagram in which a cause-and-effect relation between a flood problem of a city and an effect of a flood notification based on rainfall amount information is modeled.

FIG. 24 is a diagram illustrating a reliability block diagram of a flood alarm system.

FIG. 25 is a diagram exemplarily illustrating a final output of example 2.

### DESCRIPTION OF EMBODIMENTS

### First Example Embodiment

Description of a Configuration

Next, example embodiments of the present invention will be described in detail with reference to the accompanying drawings.

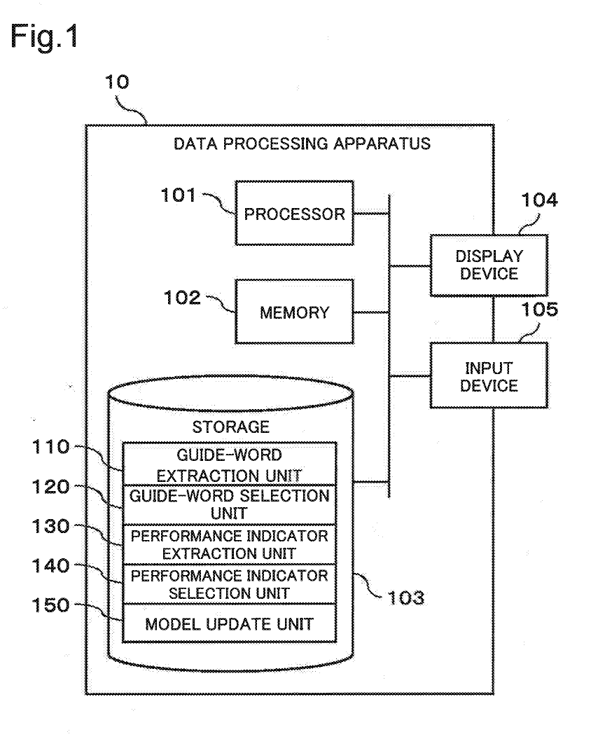

FIG. 1 is a diagram conceptually illustrating a configuration of a data processing apparatus 10 of a first example embodiment of the present invention. As illustrated in FIG. 1, the data processing apparatus 10 includes a processor 101 such as a central processing unit (CPU), a memory 102 such as a random access memory (RAM), a read only memory (ROM), and the like, a storage 103 that is a storage device such as a hard disk drive (HDD), an solid state drive (SSD), a memory card, and the like, a display device 104 such as a liquid crystal display (LCD), a cathode ray tube (CRT) display, and the like, and an input device 105 such as a keyboard, a mouse, a touch sensor, and the like that accepts input from an operator.

Further, the data processing apparatus 10 of the present example embodiment includes a guide-word extraction unit 110, a guide-word selection unit 120, a performance indicator extraction unit 130, a performance indicator selection unit 140, and a model update unit 150. Programs that store these processing units are stored on the storage 103, and these programs are read onto the memory 102 by the processor 101 and executed, whereby functions of the respective processing units of the data processing apparatus 10 are implemented.

The processing units of the data processing apparatus 10 operate roughly as described below.

The guide-word extraction unit 110 extracts, based on a name of a first node that is a node included in a social system model, at least one guide-word corresponding to the first node from a guide-word storage unit that stores correspondence between a name of a node and a guide-word.

The data processing apparatus 10 further includes, for example, a node selection unit (not illustrated) that accepts, from an operator, input for selecting a first node from respective nodes of a social system model, and the guide-word extraction unit 110 recognizes a node selected by the node selection unit as the first node. The guide-word extraction unit 110 extracts a guide-word from the guide-word storage unit by using a name assigned, as attribute information, to the node recognized as the first node. Further, without limitation to the above-described example, in a social system model, a node that is a first node may be previously assigned with predetermined attribute information, and the guide-word extraction unit 110 may be configured to determine whether each node is assigned with predetermined attribute information and recognize a node assigned with predetermined information as a first node. The predetermined attribute information is assigned, for example, in a process for generating a social system model, to a node that may produce an influence with an information communication system.

The first node refers to a node that is a target for processing of the data processing apparatus 10 to be described in the present specification among nodes included in a social system model.

Further, nodes included in a social system model are assigned with pieces of attribute information, respectively. Attribute information of a node includes, for example, a name of a node, an evaluation value (variable) of the node, a function for calculating the evaluation value, information for identifying another node to be linked (i.e. having a cause-and-effect relation) with the node, and information indicating positive or negative polarity of the cause-and-effect relation. However, attribute information other than those exemplified here may be assigned to each node. For example, information indicating whether the node is a first node may be further assigned as attribute information.

An “evaluation value (variable) of a node” is a variable obtained by quantifying each element of a social problem expressed as a social system model and is calculated, for example, by a function assigned as attribute information. The function includes, as parameters, an evaluation value of a node to be linked (i.e. having a cause-and-effect relation) with a certain node and a coefficient based on the positive or negative polarity of the cause-and-effect relation. Therefore, when with respect to a certain one node, an evaluation value of a node linked with the certain one node varies, an evaluation value of the one node also varies according to the positive or negative polarity of a cause-and-effect relation therebetween. Specifically, when there is a positive cause-and-effect relation, an evaluation value of one node varies in the same direction as a variation direction of an evaluation value of a node to be linked. When there is a negative cause-and-effect relation, an evaluation value of one node varies in a reverse direction to a variation direction of an evaluation value of a node to be linked.

The guide-word selection unit 120 accepts selection input for at least one guide-word extracted in the guide-word extraction unit 110.

The performance indicator extraction unit 130 extracts, from a performance indicator storage unit that stores correspondence between a guide-word and at least one performance indicator of an information communication system, at least one performance indicator corresponding to the guide-word selected in the guide-word selection unit 120.

The performance indicator selection unit 140 accepts selection input for the at least one performance indicator extracted in the performance indicator extraction unit 130.

The model update unit 150 associates the performance indicator selected in the performance indicator selection unit 140, as a second node, with the first node. Although being described later in detail, the second node plays a role of receiving information that calculates an influence of an information communication system model separately stored on a social system model.

These means mutually act in such a way as to newly generate a node that is a connection point between a social system model and an information communication system model and thereby associate the social system model with an information communication model.

Description of Operations

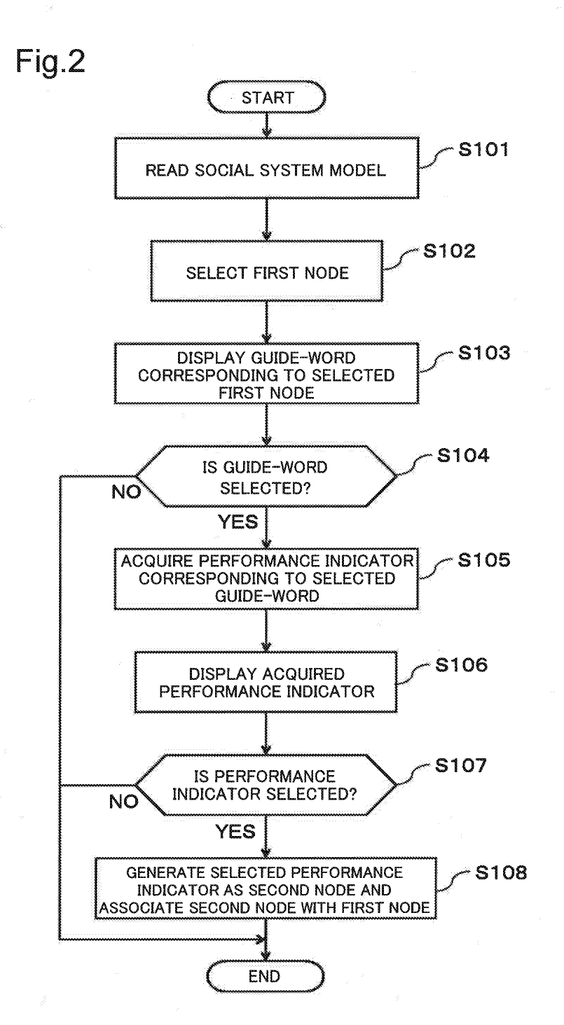

Next, with reference to a flowchart of FIG. 2, an entire operation of the present example embodiment will be described in detail. FIG. 2 is a flowchart illustrating a flow of processing of the data processing apparatus 10 of the first example embodiment. In the following operation example, exemplified is a case where a node that is a first node in a social system model is previously assigned with predetermined attribute information, and the guide-word extraction unit 110 recognizes the first node, based on predetermined attribute information assigned to each node.

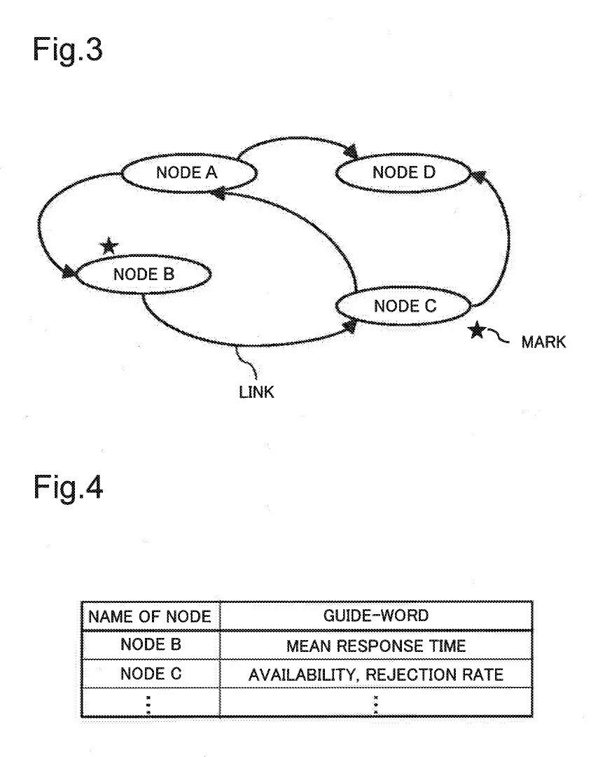

First, the data processing apparatus 10 reads a social system model from a social system model storage unit (not illustrated) that stores a social system model (S101). The social system model stored on the social system model storage unit is previously created by an administrator and the like of a system. The social system model storage unit may be included in the data processing apparatus 10 or may be included in another apparatus communicably connected to the data processing apparatus 10. The data processing apparatus 10 reads a social system model, for example, as illustrated in FIG. 3 from the social system model storage unit and displays the read model on the display device 104. FIG. 3 is a diagram illustrating one example of a social system model as input. In the example of FIG. 3, a “link” is illustrated by a line drawn between nodes. Although being not illustrated here, the positive or negative polarity of a cause-and-effect relation between nodes may be displayed together with a line indicating a link as “+” or “−”, respectively. Further, in the social system model illustrated in the example of FIG. 3, a first node is assigned with a mark of a star shape. This mark is assigned based on predetermined attribute information previously assigned to each node constructing the social system model. However, such a mark may not be displayed on a screen.

The guide-word extraction unit 110 selects one node assigned with a mark in a social system model as illustrated in FIG. 3 (S102). When there is no node previously assigned with predetermined attribute information in a read social system model, the guide-word extraction unit 110 selects all nodes one by one in order.

Next, the guide-word extraction unit 110 extracts a guide-word associated with the selected node and displays the extracted guide-word on the display device 104 (S103). Correspondence between each node and a guide-word is defined as information, for example, as illustrated in FIG. 4 and stored on a guide-word storage unit (not illustrated). FIG. 4 is a diagram illustrating one example of information stored by the guide-word storage unit. As exemplarily illustrated in FIG. 4, at least one or more guide-words are stored by being associated with a name of each node. A guide-word storage unit as illustrated in FIG. 4 may be included in the data processing apparatus 10 or may be included in another apparatus communicably connected to the data processing apparatus 10.

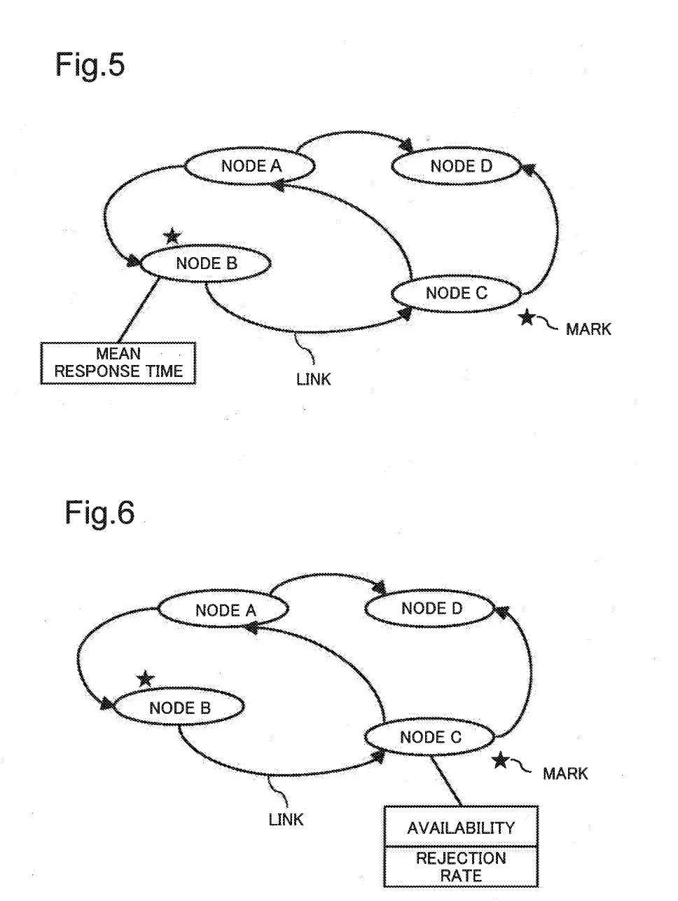

Next, the guide-word extraction unit 110 displays a screen, for example, as illustrated in FIG. 5 and FIG. 6, according to a selected node. FIG. 5 and FIG. 6 each are a diagram illustrating one example of a screen displayed when a node of a social system model is selected. Specifically, when a node B is selected in the social system model as illustrated in FIG. 3, according to information as illustrated in FIG. 4, a guide-word associated with the node B is a “mean response time.” Thereby, a guide-word of the “mean response time” is extracted, and a screen as illustrated in FIG. 5 is displayed on the display device 104. Further, when a node C is selected in the social system model as illustrated in FIG. 3, according to the information as illustrated in FIG. 4, guide-words associated with the node C are an “availability” and a “rejection rate.” Thereby, two guide-words of the “availability” and the “rejection rate” are extracted, and a screen, for example, as illustrated in FIG. 6 is displayed on the display device 104.

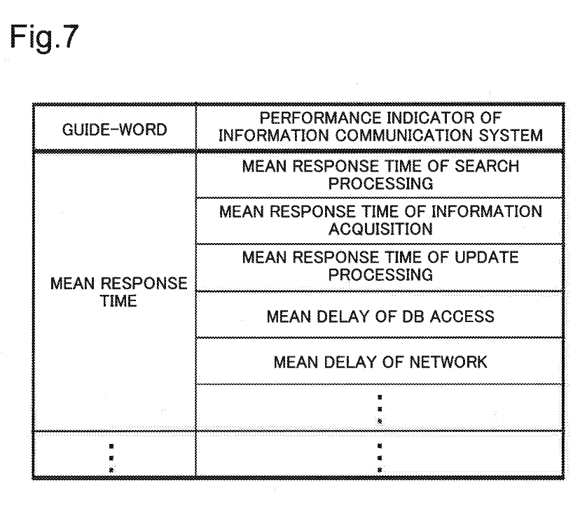

The guide-word selection unit 120 accepts, from an operator, selection input for a guide-word extracted as described above (S104). The performance indicator extraction unit 130 refers to the performance indicator storage unit that stores information, for example, as illustrated in FIG. 7 by using, as a key, the guide-word indicated by the selection input from the operator accepted in the guide-word selection unit 120 and acquires a performance indicator corresponding to the guide-word (S105). FIG. 7 is a diagram illustrating one example of the information stored by the performance indicator storage unit. As exemplarily illustrated in FIG. 7, at least one or more performance indicators with respect to an information communication system are stored by being associated with each guide-word. The performance indicator storage unit as illustrated in FIG. 7 may be included in the data processing apparatus 10 or may be included in another apparatus communicably connected to the data processing apparatus 10. The performance indicator acquired here is a performance indicator calculable by characteristics of an information communication system model defined in an information communication system model storage unit that is not illustrated. The characteristics of the information communication system model are not specifically limited and may include, for example, a processing request number per unit time in an information communication system, a processing execution number per unit time of a processing server included in the information communication system, the number of the processing servers, and an operation rate of the processing server.

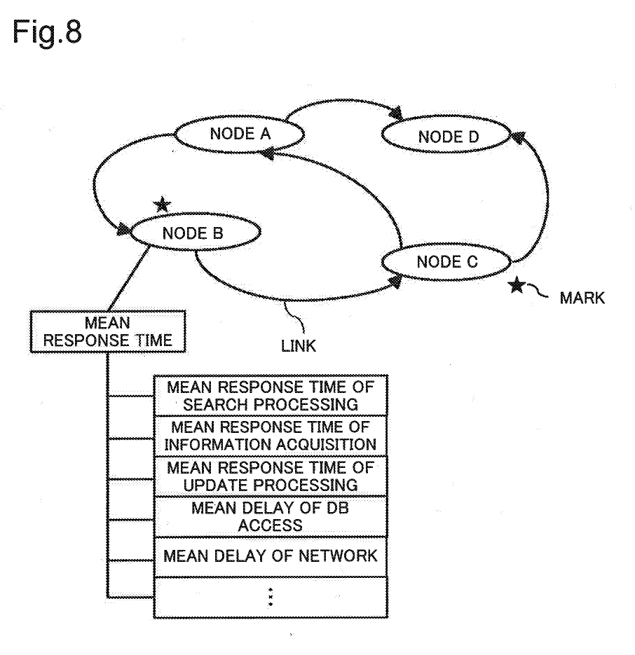

The performance indicator extraction unit 130 displays the acquired performance indicator on the display device 104, for example, as illustrated in FIG. 8 (S106). FIG. 8 is a diagram illustrating one example of a screen that displays a performance indicator acquired by the performance indicator extraction unit 130. In FIG. 8, a case where a node B is selected in S102 and a guide-word of a “mean response time” is selected in S104 is exemplarily illustrated. As illustrated in FIG. 7, the guide-word of the “mean response time” is associated with performance indicators such as a “mean response time of search processing,” a “mean response time of information acquisition,” a “mean response time of update processing,” a “mean delay of DB access,” a “mean delay of a network,” and the like, and these performance indicators are displayed on a screen.

Next, the performance indicator selection unit 140 accepts selection input for at least one performance indicator displayed on the screen (S107). When any performance indicator is selected, the model update unit 150 generates the selected performance indicator as a second node and associates the second node with the first node (S108). The model update unit 150 associates the first node with the second node, for example, as described below.

First, the model update unit 150 generates attribute information of a second node to be added to the social system model read in S101. The attribute information of the second node includes, for example, a name of a performance indicator, an evaluation value (variable) of the second node, a function for calculating the evaluation value, and information for identifying a first node of a link destination. The model update unit 150 adds the attribute information of the second node thus generated to the social system model stored on the social system model storage unit as information of a new node of the social system model read in S101 and updates a structure of the social system model. Further, the model update unit 150 updates a function for calculating an evaluation value of the first node by using an evaluation value of the second node as a new parameter. Further, the model update unit 150 further adds information indicating the positive or negative polarity of a cause-and-effect relation between the first node and the second node. Thereby, the first node of the social system model is associated with the second node of the information communication system generated in the model update unit 150.

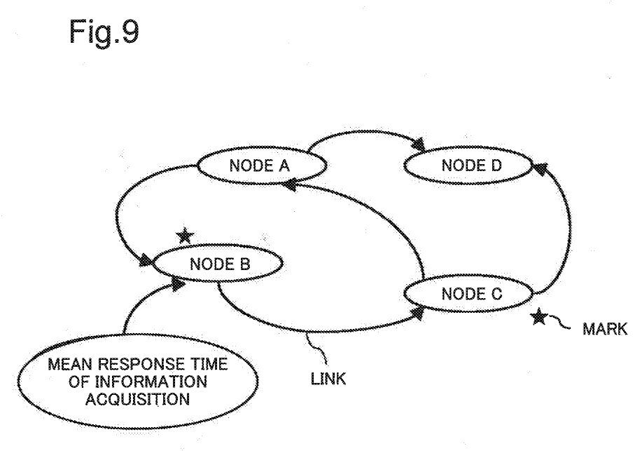

Thereafter, a model, for example, as illustrated in FIG. 9 is displayed based on the updated social system model. FIG. 9 is a diagram illustrating one example of a result of processing executed by the model update unit 150. In the example of FIG. 9, a case where among performance indicators of the information communication system extracted in S106, a performance indicator of an “mean response time of information acquisition” is selected in S107 is exemplarily illustrated. As illustrated in FIG. 9, the “mean response time of information acquisition” that is a node (second node) of the information communication system is newly linked to the “node B” that is a node (first node) of the social system model. An evaluation value of the node of the “mean response time of information acquisition” added here is calculated based on characteristics of the information communication system model stored on an information communication system model storage unit. The evaluation value of the node of the “mean response time of information acquisition” calculated here first affects an evaluation value of the node B of the social system model to be linked to the node and further, the influence spreads in a chain manner along a link. In this manner, using a newly added second node as an entrance, an information communication system model is connected to a social system model, and these models can be used in design and an operation of an optimum information communication system intended to solve a social problem.

Description of Advantageous Effects

Next, advantageous effects of the present example embodiment will be described. In the present example embodiment, the data processing apparatus clarifies, using a guide-word, a relation with a performance indicator defined in an information communication system model for a selected node of a social system model, generates a node corresponding to the performance indicator, and associates the generated node with a model of the information communication system. Thereby, a model for deriving design and an operation of an optimum information communication system intended to solve a social problem can be acquired.

In addition, in a stage where an information communication system for solving a social problem has not been completed since it is difficult to apply a conventional technique for analyzing and identifying a structure of a service by using a performance measurement value and an operation log of an information communication system, it may be difficult to generate a model for solving a problem from measurement data. However, according to the present example embodiment, without using a performance measurement value, an operation log, and the like of an information communication system, a model can be synthesized by combining a social system model and an information communication model. Therefore, according to the present example embodiment, in a stage where an information communication system for solving a social problem has not been completed, a model for solving a problem can be generated.

### Second Example Embodiment

Next, a second example embodiment of the present invention will be described in detail with reference to corresponding drawings. While in the first example embodiment, it is assumed that a guide-word is previously assigned to each node of a social system model, in the second example embodiment, a method for automatically presenting a guide-word from associated node information and a synonym dictionary is used.

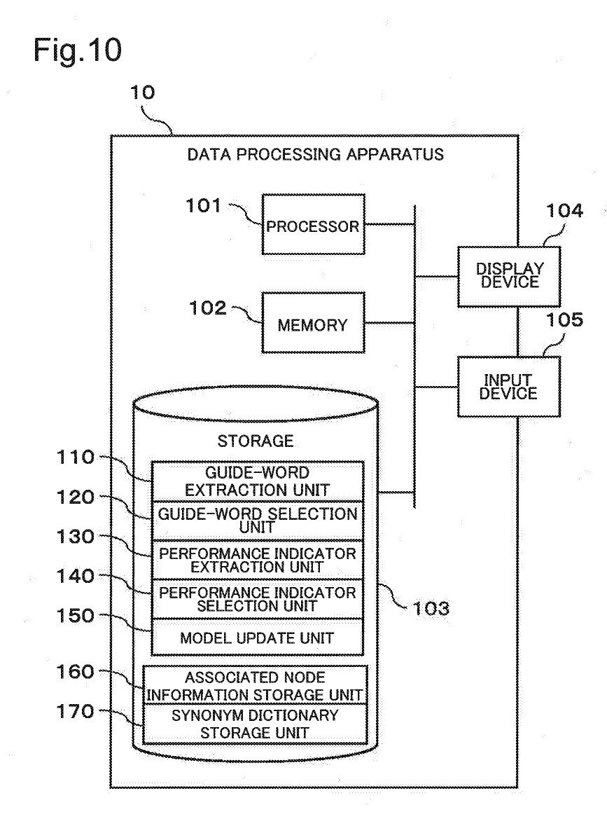

FIG. 10 is a diagram conceptually illustrating a processing configuration of a data processing apparatus 10 of the second example embodiment of the present invention. The data processing apparatus 10 of the present example embodiment includes, in addition to the configuration of the first example embodiment, an associated node information storage unit 160 and a synonym dictionary storage unit 170. The associated node information storage unit 160 and the synonym dictionary storage unit 170 may be included in another apparatus communicably connected to the data processing apparatus 10.

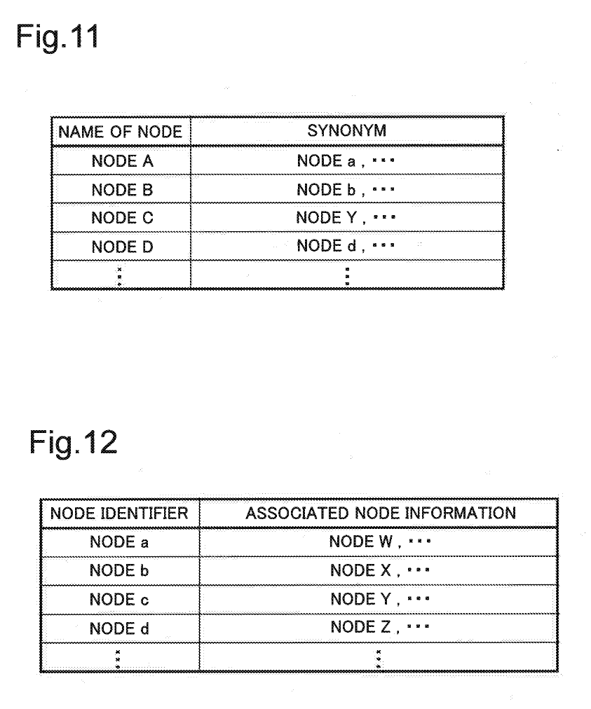

The synonym dictionary storage unit 170 stores a name of a node stored on a guide-word storage unit and a term similar to the name of the node in association with each other, for example, as illustrated in FIG. 11. FIG. 11 is a diagram illustrating one example of information stored by the synonym dictionary storage unit 170. A guide-word extraction unit 110 of the present example embodiment identifies, when a guide-word corresponding to a first node is not stored on the guide-word storage unit, a name of a node similar to a name of the first node by using the synonym dictionary storage unit 170. The guide-word extraction unit 110 extracts a guide-word corresponding to the first node from the guide-word storage unit, based on the identified name of the node. When, for example, the name of the first node is a “node b”, the guide-word extraction unit 110 identifies a “node B” similar to the “node b” from the synonym dictionary storage unit 170 illustrated in FIG. 11. The guide-word extraction unit 110 extracts, based on the identified “node B”, a guide-word of an “mean response time” from the guide-word storage unit as illustrated in FIG. 4.

The associated node information storage unit 160 stores, for example, as illustrated in FIG. 12, information of an associated node having not been employed in a process of generating a social system model in association with a node of the social system model. FIG. 12 is a diagram illustrating one example of information stored by the associated node information storage unit. In the example illustrated in FIG. 12, identification information of each node included in a social system model is stored in association with associated node information. In general, in a process of creating a social system model, various elements are investigated, but some unnecessary nodes are consolidated and deleted to simply express a final cause-and-effect relation. These nodes have appeared in a process of analysis but, nevertheless, are useful reference information, and therefore are stored on the associated node information storage unit 160 as associated information of consolidated nodes. The guide-word extraction unit 110 acquires, when a guide-word corresponding to a first node is not stored on the guide-word storage unit, associated node information stored on the associated node information storage unit 160 and searches the synonym dictionary storage unit 170 by using a node name included in the acquired associated node information as a key. The guide-word extraction unit 110 extracts a guide-word hit by searching the synonym dictionary storage unit 170 and outputs the hit guide-word to a display device 104. When, for example, the name of the first node is a “node c,” the guide-word extraction unit 110 acquires a “node Y” or the like as associated node information of the “node c” from the associated node information storage unit 160 illustrated in FIG. 12. The guide-word extraction unit 110 searches the synonym dictionary storage unit illustrated in FIG. 11, based on the acquired “node Y” and identifies a “node C” as a node similar to the “node c.” The guide-word extraction unit 110 extracts, based on the identified “node C,” guide-words of an “availability” and a “rejection rate” from the guide-word storage unit as illustrated in FIG. 4.

Associated node information does not always need to exist. As described above, the guide-word extraction unit 110 may search the synonym dictionary storage unit 170, based on only a name of a selected node.

According to such a configuration, it is possible to extract a guide-word having high similarity, based on information associated with a selected node and present the extracted guide-word to a user, even when the guide-word is not clearly specified in a social system model. When a guide-word is selected, a performance indicator of an information communication system model corresponding to the guide-word can be selected. Thereby, an operator can easily associate a social system model with an information communication system model.

### Third Example Embodiment

Next, a third example embodiment of the present invention will be described in detail with reference to corresponding drawings. While in the second example embodiment, in order to present a guide-word, the associated node information storage unit 160 and the synonym dictionary storage unit 170 are used, in the third example embodiment, when extracting and presenting a guide-word, a guide-word extraction unit 110 uses past information (a selection history of a guide-word displayed on a display device 104 as a guide-word corresponding to a first node). Further, similarly when a performance indicator extraction unit 130 presents a performance indicator, a creation history of a past performance indicator node (a selection history of a performance indicator displayed on the 104 as a performance indicator for a selected guide-word) is used.

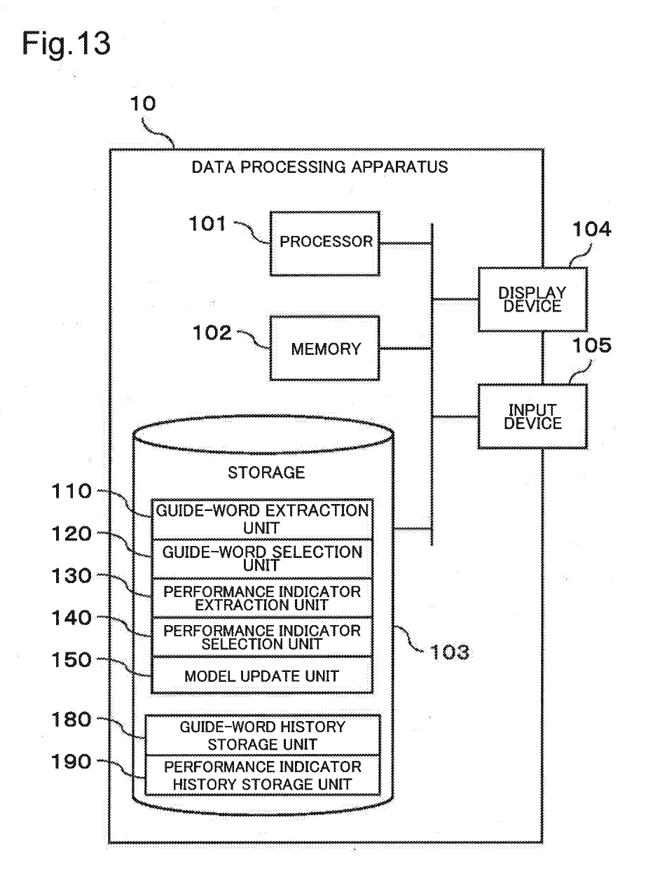

FIG. 13 is a diagram conceptually illustrating a processing configuration of a data processing apparatus 10 of the third example embodiment of the present invention. The present example embodiment includes, in addition to the configuration of the first example embodiment of the present invention, a guide-word history storage unit 180 and a performance indicator history storage unit 190. The guide-word history storage unit 180 and the performance indicator history storage unit 190 may be included in another apparatus communicably connected to the data processing apparatus 10. Further, the present example embodiment may further include the configuration of the second example embodiment.

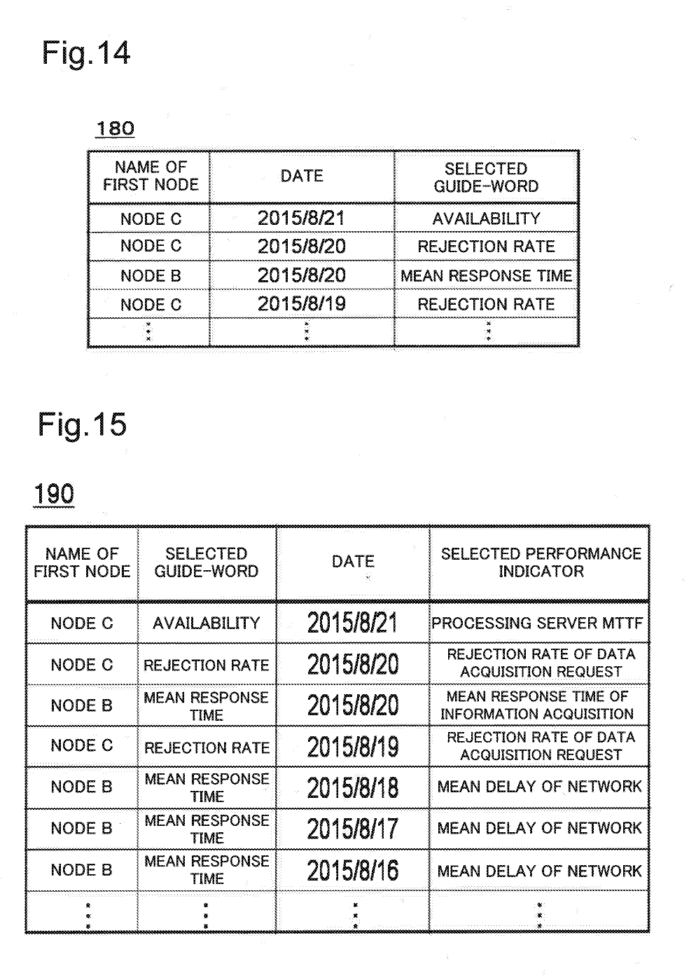

The guide-word history storage unit 180 stores statistical information representing what guide-word has been selected for a node used in a past social system model. Specifically, the guide-word history storage unit 180 stores a guide-word selected in a past time period and a name of a first node used as a basis for extracting the guide-word in association with each other. The guide-word history storage unit 180 stores information, for example, as illustrated in FIG. 14. FIG. 14 is a diagram illustrating one example of information stored on the guide-word history storage unit 180. Further, in an embodiment in which the synonym dictionary storage unit 170 is included, the guide-word history storage unit 180 may further store statistical information regarding what guide-word has been selected based on the synonym dictionary storage unit 170. This statistical information may be a result produced by a different designer or a different department. The guide-word extraction unit 110 of the present example embodiment checks, by referring to the guide-word history storage unit 180, whether there is a history in which a guide-word has been set in a past time period for a name of a first node to be processed. When there is a history, the guide-word extraction unit 110 outputs the guide-word to a display terminal. When, for example, the name of the first node is a “node C,” the guide-word extraction unit 110 extracts guide-words of an “availability” and a “rejection rate” from the guide-word history storage unit 180 illustrated in FIG. 14 and displays the extracted guide-words on the display device 104.

The performance indicator history storage unit 190 stores statistical information representing what performance indicator node has been created for a node used in a past social system model. Specifically, the performance indicator history storage unit 190 stores a performance indicator of an information communication system selected in a past time period and a combination of a node and a guide-word used as a basis for extracting the performance indicator in association with each other. The performance indicator history storage unit 190 stores information, for example, as illustrated in FIG. 15. FIG. 15 is a diagram illustrating one example of information stored on the performance indicator history storage unit 190. This information may be a result produced by a different designer or a different department. A performance indicator extraction unit 130 of the present example embodiment refers to the performance indicator history storage unit 190, based on a combination of a node and a guide-word selected and checks whether there is a history in which a performance indicator node has been generated for a node selected in a past time period. When there is a history, the performance indicator extraction unit 130 outputs the performance indicator to a display device 104. In a combination where, for example, a name of a first node is a “node C” and a guide-word is a “rejection rate”, the performance indicator extraction unit 130 extracts performance indicators of a “rejection rate of a data processing request” and a “rejection rate of a data acquisition request” from the guide-word history storage unit 180 illustrated in FIG. 15 and displays the extracted performance indicators on the display device 104.

As described above, the present example embodiment uses history information of a social system model and an information communication system model combined in a past time period and thereby can present a guide-word and a performance indicator to a user by being further narrowed. Thereby, an operator can more efficiently associate a social system model and an information communication system, based on a past result.

### Fourth Example Embodiment

In the present example embodiment, an embodiment in which respective scores of guide-words extracted in a guide-word extraction unit 110 are calculated and the guide-words are presented after being ranked based on a score for each of the guide-words will be described.

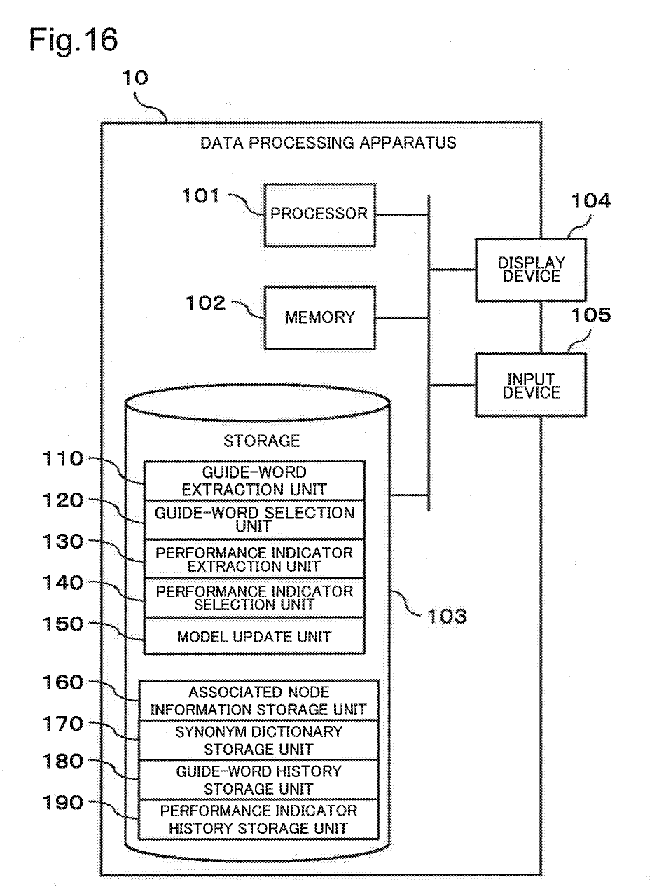

FIG. 16 is a diagram conceptually illustrating a processing configuration of a data processing apparatus 10 of a fourth example embodiment. The data processing apparatus 10 of the present example embodiment further includes, in addition to the configuration of the first example embodiment, the synonym dictionary storage unit 170 and the guide-word history storage unit 180 of FIG. 10 and the guide-word history storage unit 180 and the performance indicator history storage unit 190 of FIG. 13. A guide-word extraction unit 110 of the present example embodiment assigns a score to each extracted guide-word by using the synonym dictionary storage unit 170 that stores a name of a node stored on a guide-word storage means and a term similar to the name of the node in association with each other or the guide-word history storage unit 180 that stores a guide-word selected in a past time period and a name of a first node used as a basis for extracting the guide-word in association with each other. A score assigned to each guide-word is a numerical value indicating an extent that an extracted guide-word is suitable as a guide-word corresponding to a first node.

When selecting a guide-word by referring to a synonym dictionary, for example, based on a name of a first node and associated node information, the guide-word extraction unit 110 determines similarity to the guide-word with respect to each of the name of the first node and the associated node information and thereby can assign a score to the guide-word by using a hit item number and similarity of a term. On the other hand, when selecting a guide-word by referring to the guide-word history storage unit 180, the guide-word extraction unit 110 can assign a score to the guide-word, based on information such as a use frequency of a guide-word for a first node, newness of a history, strength of a relation with a person or department that has used the guide-word, and the like. The guide-word extraction unit 110 of the present example embodiment ranks the extracted guide-word based on the score of the guide-word and outputs the ranked guide-word on the display device 104.

As an example, a case where a first node name is a “node C” will be considered. In this case, the guide-word extraction unit 110 can rank guide-words by assigning a score to each guide-word as follows, based on the guide-word history storage unit 180 illustrated in FIG. 14. First, the guide-word extraction unit 110 recognizes that a guide-word of a “rejection rate” and a guide-word of an “availability” were selected twice and once for the “node C”, respectively, based on the guide-word history storage unit 180. According to this, the guide-word extraction unit 110 assigns a higher score to the guide-word of the “rejection rate” than the guide-word of the “availability” with respect to a use frequency. Further, the guide-word extraction unit 110 recognizes that most recently, the guide-word of the “availability” was selected and then the “rejection rate” was selected. According to this, the guide-word extraction unit 110 assigns a higher score to the guide-word of the “availability” than the guide-word of the “rejection rate” with respect to newness of a history. The guide-word extraction unit 110 calculates, for each guide-word, a mean value, an intermediate value, a total value, and the like of scores and ranks guide-words, based on the score calculated for each guide-word.

As describe above, the present example embodiment is configured to present, to a user, a result obtained by scoring for each guide-word and ranking based on the score, based on similarity of a term, a history stored on the performance indicator history storage unit 190, and the like. The ranking of guide-words based on scores helps an operator to select a guide-word. Thereby, the operator can more efficiently associate a social system model with an information processing system.

### Fifth Example Embodiment

In the present example embodiment, an embodiment in which a score of each of performance indicators extracted by a performance indicator extraction unit 130 is calculated and the performance indicators are ranked and presented, based on the score of each performance indicator will be described.

A data processing apparatus 10 of the present example embodiment includes a configuration similar to that of FIG. 16. The performance indicator extraction unit 130 of the present example embodiment assigns a score to each extracted performance indicator by using a performance indicator history storage means for storing a performance indicator of an information communication system selected in a past time period and a combination of a node and a guide-word used as a basis for extracting the performance indicator in association with each other. A score assigned to each guide-word here is a numerical value indicating to what extent an extracted performance indicator is suitable as a performance indicator corresponding to a combination of a first node and a guide-word.

As an example, a case where a name of a first node is a “node B” and a guide-word is a “mean response time” will be considered. In this case, the performance indicator extraction unit 130 of the present example embodiment assigns a score to each performance indicator as follows, based on the performance indicator history storage unit 190 illustrated in FIG. 15 and thereby can rank performance indicators. First, the performance indicator extraction unit 130 recognizes that a performance indicator of a “mean response time of information acquisition” and a performance indicator of a “mean delay of a network” were selected once and three times, respectively, for a combination of a “node B” and a “mean response time,” based on the performance indicator history storage unit 190. According to this, the performance indicator extraction unit 130 assigns a higher score to the performance indicator of the “mean delay of a network” than the performance indicator of the “mean response time of information acquisition” with respect to a use frequency. Further, the performance indicator extraction unit 130 recognizes that most recently, the performance indicator of the “mean response time of information acquisition” was selected and then the “mean delay of a network” was selected. According to this, the performance indicator extraction unit 130 assigns a higher score to the performance indicator of the “mean response time of information acquisition” than the performance indicator of the “mean delay of a network” with respect to newness of a history. The performance indicator extraction unit 130 calculates, for each performance indicator, a mean value, an intermediate value, a total value, and the like of the scores assigned and ranks guide-words, based on the score calculated for each performance indicator.

Although there is a plurality of performance indicators corresponding to a specified guide-word, in the present example embodiment, using history information used in a past time period, performance indicators can be scored based on a use frequency, newness of a history, and the like. Thereby, the performance indicator extraction unit 130 of the present example embodiment can output a plurality of extracted performance indicators to the display device 104 by being ranked based on scores. The ranking of performance indicators based on scores helps an operator to select a performance indicator. Thereby, a user more easily selects a performance indicator and thereby an operator can more efficiently associate a social system model with an information communication system.

### Sixth Example Embodiment

In the present example embodiment, an embodiment in which a guide-word having a highest score is automatically selected in addition to the fourth example embodiment will be described. Further, in the present example embodiment, an embodiment in which a performance indicator having a highest score is automatically selected in addition to the fifth example embodiment will be described.

A data processing apparatus 10 of the present example embodiment includes a configuration similar to that of FIG. 16. A guide-word selection unit 120 of the present example embodiment selects a guide-word having a highest score calculated as described in the fourth example embodiment among guide-words extracted by a guide-word extraction unit 110. Further, a performance indicator selection unit 140 of the present example embodiment selects a performance indicator having a highest score calculated as described in the fifth example embodiment among at least one performance indicator extracted by a performance indicator extraction unit 130. A model update unit 150 generates a node of the selected performance indicator as a second node and associates the second node with a first node.

As described above, in the present example embodiment, the guide-word selection unit 120 and the performance indicator selection unit 140 are configured to select a guide-word and a performance indicator having highest scores, based on score information, respectively. Thereby, without input of a user, a social system model and an information communication system can be associated with each other.

### Example 1

Next, using specific examples, operations of the example embodiments of the present invention will be described.

Safety management of a public facility, a railroad station, and the like where a large number of people gather is one important problem in an urbanized society. There are various crime risks from a minor offence such as theft and the like to terrorism and a property destruction action using an explosive substance, particularly during an event and the like where people gather. In order to prevent such a crime beforehand, suspicious behavior and suspicious person identification using a security camera together with patrol acts of a security guard is used. An image captured by a security camera is analyzed by image analysis processing, and a suspicious behavior and a suspicious person are determined and notified to a security guard and the like. A situation where a problem of safety management of a facility using such a security camera is modeled using a social system model will be considered.

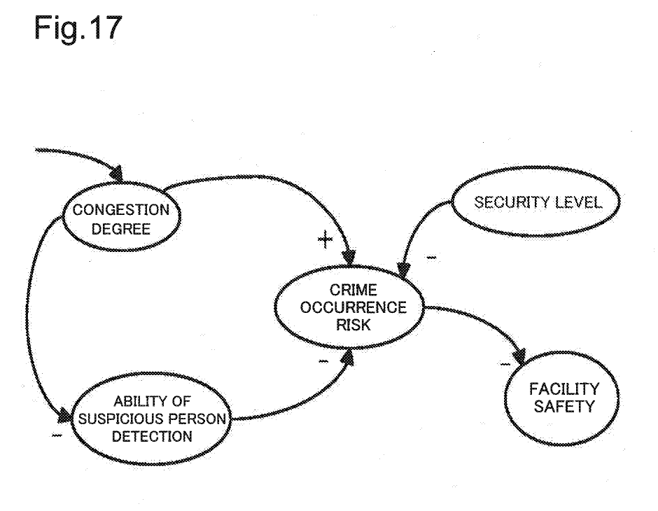

FIG. 17 illustrates a cause-and-effect relation diagram in which a cause-and-effect relation between a safety management problem of a facility and value provision of a suspicious behavior and person identification function by a security camera is modeled. It is assumed that this model is created by a customer actually facing a social problem and a problem solution provider that provides a means for solving a problem. A cause-and-effect relation diagram is expressed by nodes (ellipses) and a link connecting the nodes. Each node represents a variable corresponding to an event of a society. The link represents a cause-and-effect relation between two variables. A link having a “+” sign represents a positive cause-and-effect relation, i.e. represents that there is a relation in which when a value of a variable of a link source increases, a value of a variable of a link destination also increases. Conversely, a link having a “−” sign represents a negative cause-and-effect relation, i.e. represents that there is a relation in which when a value of a variable of a link source increases, a value of a variable of a link destination conversely decreases. In the cause-and-effect relation diagram of FIG. 17, a relation between a variable representing a congestion degree of a targeted facility and a variable representing a crime occurrence risk in the facility is connected by a positive link. In other words, this represents a relation in which when a congestion degree of the facility is higher, a crime occurrence risk is higher, and conversely, when a congestion degree of the facility is lower, a crime occurrence degree is lower. On the other hand, a variable representing a crime occurrence risk has a negative link for a variable representing safety of the facility. In other words, this indicates that when a crime occurrence risk becomes higher, safety of the facility becomes lower, and conversely, when a crime occurrence degree becomes lower, safety of the facility becomes higher. The problem solution provider studies a solution means effective for a final target that safety of the facility is maintained and adds variables of a security level and an ability of suspicious person detection to the cause-and-effect relation diagram. These nodes have a negative link for a crime occurrence risk. As one means for improving an ability of suspicious person detection, there is a suspicious behavior and person identification function using a security camera. Further, it is understood that the ability of suspicious person detection has a negative link from the node of the congestion degree. In other words, when the congestion degree is high, the ability of suspicious person detection lowers. When a cause-and-effect relation diagram is used in this manner, a cause-and-effect relation between a social problem and a means of solution thereto can be captured in a bird's eye view manner. Such a cause-and-effect relation diagram may be a content in which understanding can be shared between a customer that is a concerned party to a problem and a problem solution provider and does not need to strictly capture all phenomena.

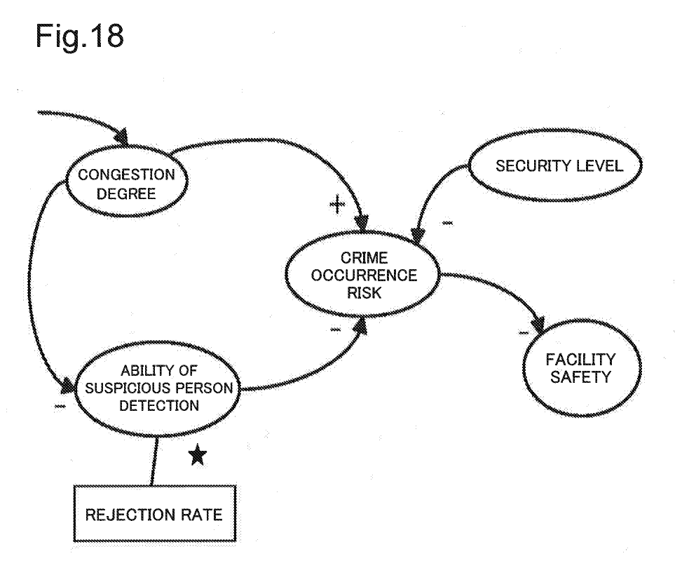

FIG. 18 is a diagram illustrating an example in which a mark and a guide-word are additionally written in the cause-and-effect relation diagram of FIG. 17. It is thought that a problem solution provider increases an ability of suspicious person detection by using a security camera system (information communication system). Therefore, the problem solution provider assigns a mark to indicate that there is a possibility that a node of the ability of suspicious person detection is associated with a model of the information communication system and further sets a rejection rate as a guide-word. As guide-words, a mean response time and an availability may be set. The guide-word itself indicates a classification of quality of the information communication system and does not identify what indicator the guide-word is specifically. The problem solution provider that assigns a guide-word expresses that an ability of suspicious person detection and a rejection rate may be associated with each other by using a guide-word.

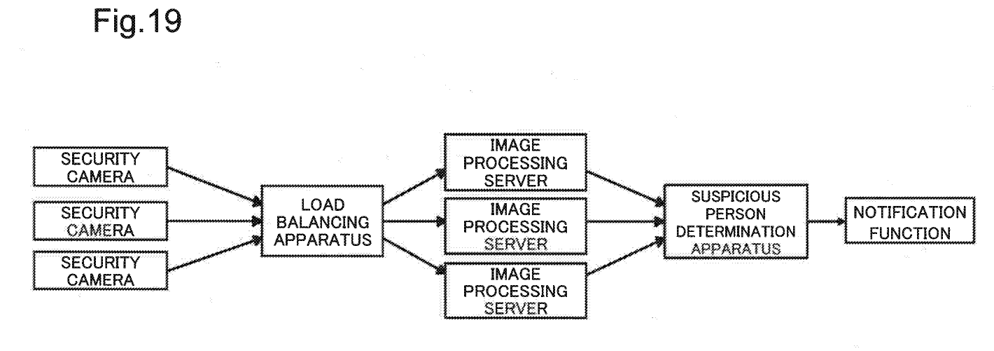

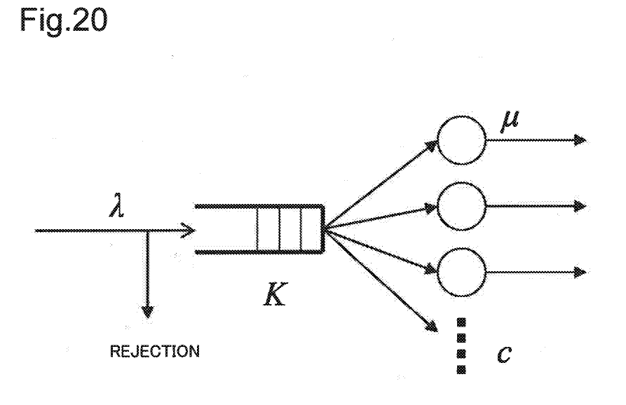

On the other hand, it is assumed that an information communication system for analyzing an image of a security camera and identifying a suspicious person is provided with a system configuration as in FIG. 19. FIG. 19 is a diagram exemplarily illustrating a configuration of an information communication system of example 1. A plurality of security cameras installed in a facility is connected to a network and transmits a recorded video to a load balancing apparatus. The load balancing apparatus is connected to a plurality of servers for executing image processing and performs load balancing according to an amount of processing. The image processing server extracts information necessary for suspicious person determination by an image processing algorithm and transfers the information to a suspicious person determination apparatus. The suspicious person determination apparatus matches the information transmitted from the image processing server against information stored on a database, determines whether the information indicates a suspicious person, and outputs a message by a notification function when a suspicious person has been detected. In general, an image processing algorithm consumes a large number of computer resources and therefore such a load balancing configuration is frequently employed. A total amount of loads varies according to the numbers of objects and persons appearing in a security camera. When performance of a system including such a load balancing configuration is analyzed, a queuing model is widely used. FIG. 20 is a diagram illustrating an example of a queuing model including “c” processing servers and a buffer area of a size “K”. When it is assumed that an arrival process of an image processing request is a Poisson process of an arrival rate “k” and it is assumed that a service time in each server follows an exponential distribution of a service rate “μ”, the queuing model can be expressed by a model referred to as an “M/M/c/K”. Upon new arrival of an image processing request when a buffer of a capacity “K” is entirely filled, the image processing request is rejected. From a well-known analysis result of an “M/M/c/K” model, a probability of rejection of a request that has arrived is given by the following equation “z”.

$$z = \frac{{ρ}^{c}}{c !} {( \frac{ρ}{c} )}^{K} \cdot {π}_{0} \\ ρ = \frac{λ}{μ} , {π}_{0} = {[ {\sum }_{k = 0}^{c - 1} \frac{{ρ}^{k}}{k !} + {\sum }_{k = c}^{c + K} \frac{{ρ}^{c}}{c !} {( \frac{ρ}{c} )}^{k - c} ]}^{- 1} \qquad [ Math . 1 ]$$

A value calculated using this calculation equation is defined as a rejection rate of an image processing request. It is possible to calculate a mean response time, a mean throughput, and the like by analyzing a queuing model.

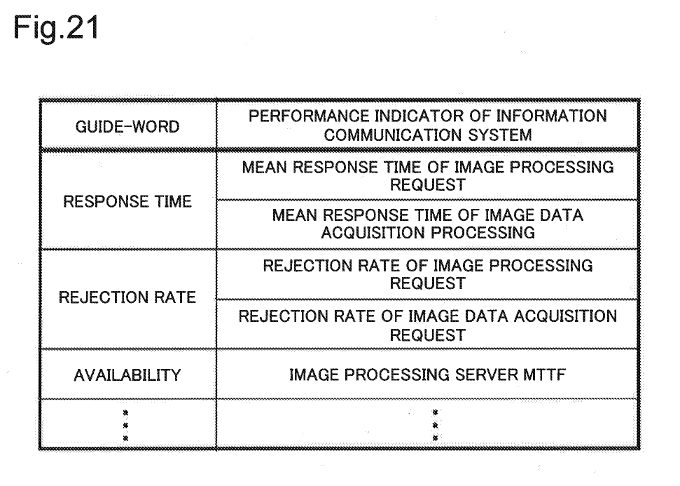

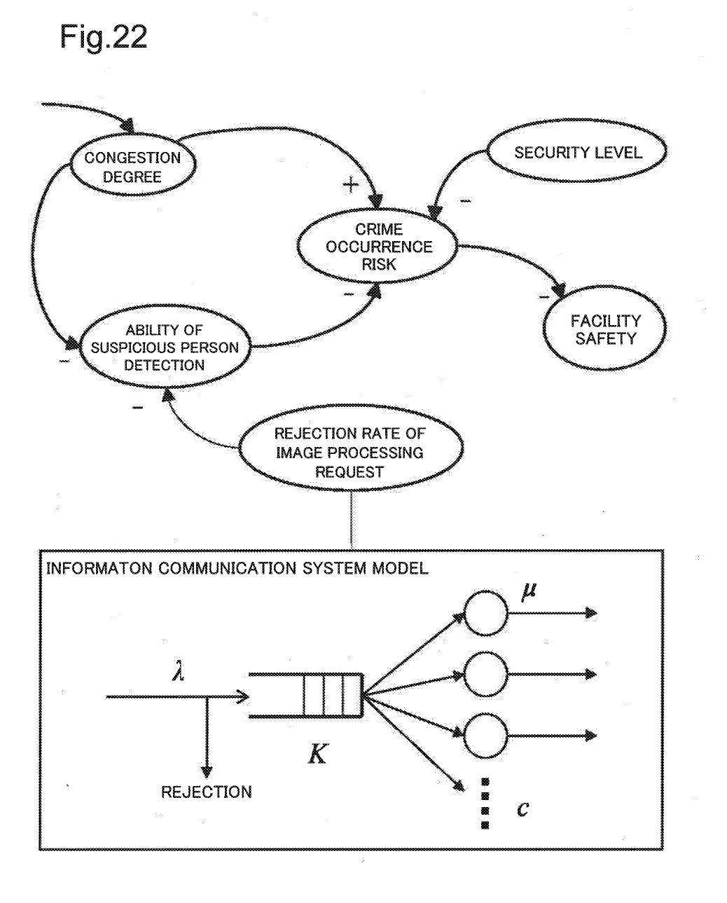

From the cause-and-effect relation diagram of FIG. 18 and the information communication system model of FIG. 19, a social system model is generated by a system model synthesis method of the present invention. First, a node selection means selects a node of an ability of suspicious person detection that is a marked node from the cause-and-effect relation diagram of FIG. 18. Next, the guide-word extraction unit 110 outputs, to the display device 104, a rejection rate that is a guide-word assigned to the node. A user selects the rejection rate, and the guide-word selection unit 120 accepts the selected rejection rate. The performance indicator extraction unit 130 acquires a performance indicator corresponding to the selected guide-word from a performance indicator storage unit as illustrated in FIG. 21. FIG. 21 is a diagram illustrating one example of information stored by a performance indicator storage unit of example 1. The performance indicator storage unit stores correspondence between a performance indicator actually defined in a model of a targeted information system and a guide-word representing a category of the performance indicator. The performance indicator extraction unit 130 refers to the performance indicator storage unit of FIG. 21 and extracts a rejection rate of an image processing request and a rejection rate of an image data acquisition request as performance indicators corresponding to the rejection rate. The performance indicator extraction unit 130 outputs this result to the display device 104. The user selects the rejection rate of the image processing request from the presented performance indicators of the rejection rate, and the performance indicator selection unit 140 accepts the selected rejection rate of the image processing request. Then, the model update unit 150 newly generates a node representing the rejection rate of the image processing request and links the node to a node of an ability of suspicious person detection. Finally, as illustrated in FIG. 22, a social system model and an information communication model are associated with each other. FIG. 22 is a diagram exemplarily illustrating a final output of example 1. It is possible to calculate a specific rejection rate of an image processing request for an image processing request by an information communication model, and when using a value thereof, a social system model is analyzed, it is possible to analyze an influence of a rejection rate of an image processing request and a change of a value thereof on facility safety that is a final social value. Further, conversely, it is possible to derive a rejection rate of an image processing request necessary for maintaining safety to be achieved and determine, based on the result, an optimum configuration of an information communication system. When, for example, a buffer size “K”, the number of image processing servers “c”, and the like are adjusted, a configuration of an information communication system that satisfies a rejection rate of an image processing request to be achieved can be determined.

While in the above description, as a model for a performance evaluation, a queuing model was used, a Petri net, a workflow diagram, a sequence diagram, a PERT chart, or the like may be used as a model for evaluating performance of an information system.

### Example 2

Next, an operation of the example embodiments of the present invention will be described using another example.

Due to population concentration in urban areas and influences of climate changes, over recent years, flood damage has frequently occurred in urban areas. Due to sudden, concentrated rainfall, rainwater is pooled in side ditches and underground areas in a short period of time beyond a drain capacity of a city, and therefore there is a risk in which a large number of citizens are exposed to dangers. In order to avoid bodily injuries due to a flood, it is important to urge citizens staying in dangerous areas to evacuate at an appropriate timing. A flood alarm system intended for an alarm notification at such an appropriate timing is used. A rainfall amount is monitored by a rainfall sensor disposed in each location of a city, it is determined that there is a risk of a flood when the rainfall amount exceeds a certain level, and an evacuation alarm is transmitted to contact information of citizens pre-registered in the system. When arriving at citizens at an appropriate timing, an evacuation alarm can urge the citizens to act to evaluate damage of a flood. A situation where such a flood problem of a city and a solution means thereof are modeled by a social system model will be considered.

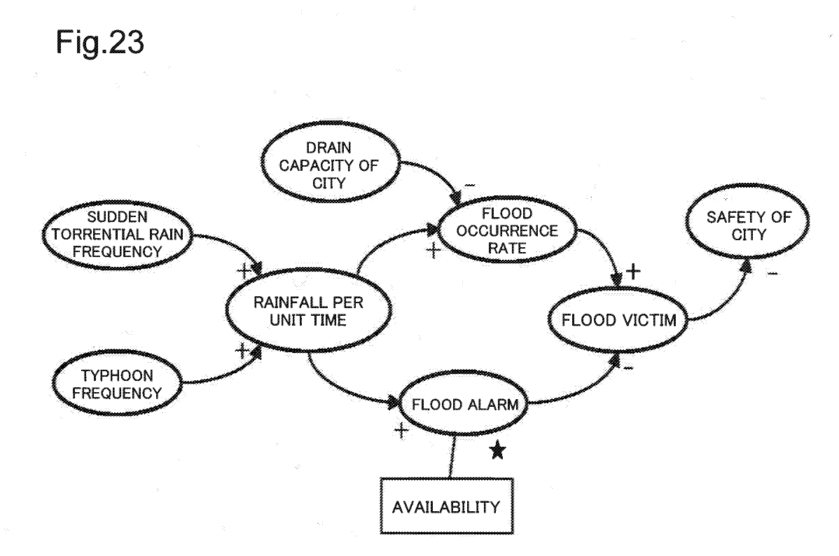

FIG. 23 illustrates a cause-and-effect relation diagram in which a cause-and-effect relation between a flood problem of a city and an effect of a flood notification based on rainfall amount information is modeled. A rainfall amount per unit time is affected by a sudden torrential rain frequency, a typhoon frequency, and the like. Therefore, nodes representing these elements are connected with a positive link. When a rainfall amount increases, a flood occurrence rate becomes higher, and therefore a positive link is connected from a node indicating a rainfall amount per unit time to a node representing a flood occurrence rate. Occurrence of a flood can be suppressed when a drain capacity of a city is high, and therefore a node representing a drain capacity of a city and a node of a flood occurrence rate are connected by a negative link. When the flood occurrence rate becomes higher, a flood victim number may increase. On the other hand, a flood alarm is generated when a rainfall amount increases, and when the flood alarm is appropriately transmitted to citizens, an increase of flood victims can be suppressed even when a flood occurs. Therefore, a node representing a flood alarm and a node representing a flood victim are connected by a negative link. An increase of flood victims is a factor for impairing safety of a city, and therefore a negative link is connected from the node of the flood victim to a node representing safety of a city. From such a cause-and-effect relation diagram, information regarding a cause of a flood, an undesirable social situation caused thereby, and a clue for improving the situation are organized as a cause-and-effect relation. A proposer that proposes a problem solution means using a flood alarm system marks a node of a flood alarm to represent connection to an information communication system and assigns an availability as a guide-word. It is important that an evacuation alarm is reliably transmitted during flood, and therefore importance is placed on availability in a problem solution.

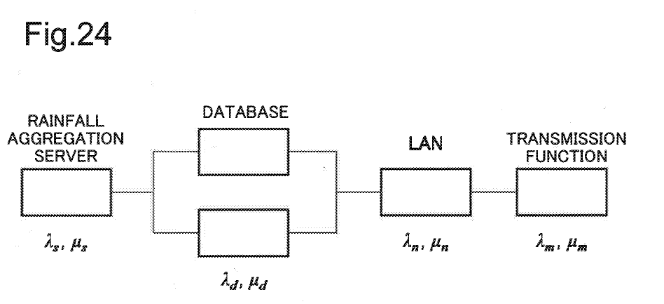

On the other hand, a system that generates a flood alarm, based on a monitoring result of a rainfall amount roughly includes a rainfall aggregation server, a database, a transmitter for transmitting a message, and a local area network (LAN) that connects these units. As a model for analyzing availability thereof of the system, a reliability block diagram can be used. FIG. 24 illustrates a reliability block diagram of a flood alarm system. When any of the rainfall aggregation server, the database, and the transmitter breaks down, a flood alarm cannot be appropriately generated, and therefore blocks corresponding to these components are connected in series. It is assumed that the database is duplicated to protect important data. Therefore, the database has a parallel configuration in the reliability block diagram. When a failure rate of a component i is designated as “λi”, a restoration rate is designated as “μi”, and the component is any one of an aggregation server (s), a database (d), a network (n), and a transmitter (m), availability of the flood alarm system illustrated by the reliability block diagram of FIG. 24 is calculated by the following equation,

$$A = \frac{{μ}_{s}}{{λ}_{s} + {μ}_{s}} \cdot [ 1 - {( \frac{{λ}_{d}}{{λ}_{d} + {μ}_{d}} )}^{2} ] \cdot \frac{{μ}_{n}}{{λ}_{n} + {μ}_{n}} \cdot \frac{{μ}_{m}}{{λ}_{m} + {μ}_{m}} \qquad [ Math . 2 ]$$

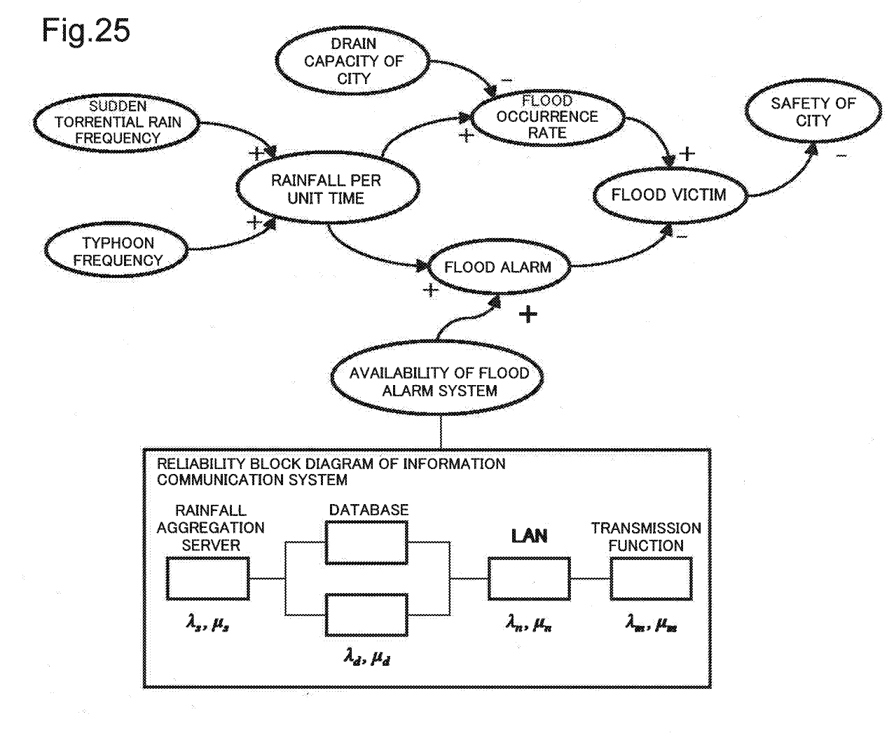

A value calculated by this calculation equation is defined as flood alarm system availability. By analyzing the reliability block diagram, it is possible to calculate reliability and a mean failure time as the system. From the cause-and-effect relation diagram of FIG. 23 and the information communication system model of FIG. 24, a social system model is generated by the system model synthesis method of the present invention. First, a node selection means selects a node of a flood alarm that is a marked node from the cause-and-effect relation diagram of FIG. 23. Then, the guide-word extraction unit 110 outputs an availability of a guide-word assigned to the node to the display device 104. It is assumed that a user has selected the availability and the guide-word selection unit 120 has accepted the selected availability. The performance indicator extraction unit 130 acquires a performance indicator corresponding to the selected guide-word from a performance indicator storage unit. The performance indicator storage unit in the present example includes a flood alarm system availability as a performance indicator corresponding to a guide-word of an “availability”. When the user selects a flood alarm system availability, the performance indicator selection unit 140 accepts the selected availability, and the model update unit 150 newly generates a node expressing a flood alarm system availability and links the node to the node of the flood alarm. Finally, as illustrated in FIG. 25, a social system model and an information communication model are associated with each other. FIG. 25 is a diagram exemplarily illustrating a final output of example 2.

A flood alarm system availability can be calculated by a reliability block diagram, and when using a value thereof, a social system model is analyzed, it is possible to analyze an influence of a flood alarm system availability and a change of a value thereof on safety of a city that is a final social value. Further, conversely, it is possible to derive a flood alarm system availability necessary for maintaining safety to be achieved of a city and design, based on the result, a system configuration for achieving availability of a flood alarm system.

While a reliability block diagram was used for an availability evaluation, as a model for evaluating availability and reliability of an information system, a Markov model, a Petri net, or a fault tree may be used.

### INDUSTRIAL APPLICABILITY

The present invention is applicable to applications including a social system model creation support apparatus for solving a social problem and a program causing a computer to realize the social system model creation support apparatus. Further, the present invention is applicable to applications including a social value evaluation apparatus that evaluates, based on a social system model, how design of an information communication system is usable to solve a social problem and a program causing a computer to realize the social value evaluation apparatus. Further, the present invention is applicable to applications including an information communication system-optimizing configuration design apparatus that derives, based on a social system model, an optimum configuration of an information communication system necessary for solving a social problem and a program causing a computer to realize the information communication system-optimizing configuration design apparatus.

While as describe above, the example embodiments of the present invention have been described with reference to the accompanying drawings, these example embodiments are illustrative of the present invention, and various configurations other than the above are employable.

Further, in the flowcharts used in the above description, a plurality of steps (processing) is described in order, but an execution order of steps executed in each example embodiment is not limited to the described order. In each example embodiment, an order of steps illustrated can be modified in a range of no obstacle to a content. Further, the example embodiments can be combined in a range where contents do not conflict.

Examples of relevant embodiments will be supplementarily described.

1.

A data processing apparatus including:

a guide-word extraction means for extracting, based on a name of a first node that is a node included in a social system model, at least one guide-word corresponding to the first node from a guide-word storage means for storing correspondence between a name of a node and a guide-word;

a guide-word selection means for accepting selection input for the at least one guide-word being extracted;

a performance indicator extraction means for extracting, from a performance indicator storage means for storing correspondence between a guide-word and at least one performance indicator regarding an information communication system, at least one performance indicator corresponding to the guide-word being selected;

a performance indicator selection means for accepting selection input for the at least one performance indicator being extracted; and

a model update means for associating, as a second node, the performance indicator being selected with the first node.

2.

The data processing apparatus according to 1., further including

a node selection means for accepting selection input of the first node, wherein

the guide-word extraction means extracts a guide-word corresponding to the first node being selected.

3.

The data processing apparatus according to 1. or 2., wherein

the guide-word extraction means

identifies, from a synonym dictionary storage means for storing a name of a node stored on the guide-word storage means and a term similar to the name of the node in association with each other, a name of a node similar to a name of the first node when a guide-word corresponding to the first node is not stored on the guide-word storage means, and

extracts a guide-word corresponding to the first node from the guide-word storage means, based on the identified name of the node.

4.

The data processing apparatus according to any one of 1. to 3., wherein

the guide-word extraction means

extracts, from a guide-word history storage means for storing a guide-word selected in a past time period and a name of a first node used as a basis for extracting the guide-word in association with each other, a guide-word corresponding to the first node, based on the name of the first node.

5.

The data processing apparatus according to any one of 1. to 4., wherein

the performance indicator extraction means

extracts, from a performance indicator history storage means for storing a performance indicator selected in a past time period of the information communication system and a combination of a node and a guide-word used as a basis for extracting the performance indictor in association with each other, a performance indicator corresponding to the node being selected.

6.

The data processing apparatus according to any one of 1. to 5., wherein

the guide-word extraction means

assigns, using the synonym dictionary storage means for storing a name of a node stored on the guide-word storage means and a term similar to the name of the node in association with each other or the guide-word history storage means for storing a guide-word selected in a past time period and a name of a first node used as a basis for extracting the guide-word in association with each other, a score to each guide-word being extracted.

7.

The data processing apparatus according to any one of 1. to 6., wherein

the performance indicator extraction means

assigns, using the performance indicator history storage means for storing a performance indicator selected in a past time period of the information communication system and a combination of a node and a guide-word used as a basis for extracting the performance indictor in association with each other, a score to each performance indicator being extracted.

8.

The data processing apparatus according to 6., wherein

the guide-word selection means selects a guide-word where the score is highest among the guide-words being extracted.

9.

The data processing apparatus according to 7., wherein

the performance indicator selection means

selects a performance indicator where the score is highest among the at least one performance indicator being extracted.

10.

A data processing method for causing

a computer to execute processing including:

extracting, based on a name of a first node that is a node included in a social system model, at least one guide-word corresponding to the first node from a guide-word storage means for storing correspondence between a name of a node and a guide-word;

accepting selection input for the at least one guide-word being extracted;

extracting, from a performance indicator storage means for storing correspondence between a guide-word and at least one performance indicator regarding an information communication system, at least one performance indicator corresponding to the guide-word being selected;

accepting selection input for the at least one performance indicator being extracted; and

associating, as a second node, the performance indicator being selected with the first node.

11.

The data processing method according to 10. for causing

the computer to execute processing including:

accepting selection input of the first node; and

extracting a guide-word corresponding to the first node being selected.

12.

The data processing method according to 10. or 11. for causing

the computer to execute processing including:

identifying, from a synonym dictionary storage means for storing a name of a node stored on the guide-word storage means and a term similar to the name of the node in association with each other, a name of a node similar to a name of the first node when a guide-word corresponding to the first node is not stored on the guide-word storage means; and

extracting a guide-word corresponding to the first node from the guide-word storage means, based on the identified name of the node.

13.

The data processing method according to any one of 10. to 12. for causing

the computer to execute processing including

extracting, from a guide-word history storage means for storing a guide-word selected in a past time period and a name of a first node used as a basis for extracting the guide-word in association with each other, a guide-word corresponding to the first node, based on the name of the first node.

14.

The data processing method according to any one of 10. to 13. for causing

the computer to execute processing including

extracting, from a performance indicator history storage means for storing a performance indicator selected in a past time period of the information communication system and a combination of a node and a guide-word used as a basis for extracting the performance indictor in association with each other, a performance indicator corresponding to the node being selected.

15.

The data processing method according to any one of 10. to 14. for causing

the computer to execute processing including

assigning, using the synonym dictionary storage means for storing a name of a node stored on the guide-word storage means and a term similar to the name of the node in association with each other or the guide-word history storage means for storing a guide-word selected in a past time period and a name of a first node used as a basis for extracting the guide-word in association with each other, a score to each guide-word being extracted.

16.

The data processing method according to any one of 10. to 15. for causing

the computer to execute processing including

assigning, using the performance indicator history storage means for storing a performance indicator selected in a past time period of the information communication system and a combination of a node and a guide-word used as a basis for extracting the performance indictor in association with each other, a score to each performance indicator being extracted.

17.

The data processing method according to 15. for causing

the computer to execute processing including selecting a guide-word where the score is highest among the guide-words being extracted.

18.

The data processing method according to 16. for causing

the computer to execute processing including

selecting a performance indicator where the score is highest among the at least one performance indicator being extracted.

19.

A program for causing

a computer to function as:

a guide-word extraction means for extracting, based on a name of a first node that is a node included in a social system model, at least one guide-word corresponding to the first node from a guide-word storage means for storing correspondence between a name of a node and a guide-word;

a guide-word selection means for accepting selection input for the at least one guide-word being extracted;

a performance indicator extraction means for extracting, from a performance indicator storage means for storing correspondence between a guide-word and at least one performance indicator regarding an information communication system, at least one performance indicator corresponding to the guide-word being selected;

a performance indicator selection means for accepting selection input for the at least one performance indicator being extracted; and

a model update means for associating, as a second node, the performance indicator being selected with the first node.

20.

The program according to 19. for causing

the computer to function as:

a node selection means for accepting selection input of the first node; and

the guide-word extraction means for extracting a guide-word corresponding to the first node being selected.

21.

The program according to 19. or 20. for causing

the computer to function as

the guide-word extraction means for

identifying, from a synonym dictionary storage means for storing a name of a node stored on the guide-word storage means and a term similar to the name of the node in association with each other, a name of a node similar to a name of the first node when a guide-word corresponding to the first node is not stored on the guide-word storage means, and

extracting a guide-word corresponding to the first node from the guide-word storage means, based on the identified name of the node.

22.

The program according to any one of 19. to 21. for causing

the computer to function as

the guide-word extraction means for

extracting, from a guide-word history storage means for storing a guide-word selected in a past time period and a name of a first node used as a basis for extracting the guide-word in association with each other, a guide-word corresponding to the first node, based on the name of the first node.

23.

The program according to any one of 19. to 22. for causing

the computer to function as

the performance indicator extraction means for

extracting, from a performance indicator history storage means for storing a performance indicator selected in a past time period of the information communication system and a combination of a node and a guide-word used as a basis for extracting the performance indictor in association with each other, a performance indicator corresponding to the node being selected.

24.

The program according to any one of 19. to 23. for causing

the computer to function as

the guide-word extraction means for

assigning, using the synonym dictionary storage means for storing a name of a node stored on the guide-word storage means and a term similar to the name of the node in association with each other or the guide-word history storage means for storing a guide-word selected in a past time period and a name of a first node used as a basis for extracting the guide-word in association with each other, a score to each guide-word being extracted.

25.

The program according to any one of 19. to 24. for causing

the computer to function as

the performance indicator extraction means for

assigning, using the performance indicator history storage means for storing a performance indicator selected in a past time period of the information communication system and a combination of a node and a guide-word used as a basis for extracting the performance indictor in association with each other, a score to each performance indicator being extracted.

26.

The program according to 24. for causing

the computer to function as

the guide-word selection means for selecting a guide-word where the score is highest among the guide-words being extracted.

27.

The program according to 25. for causing

the computer to function as

the performance indicator selection means for

selecting a performance indicator where the score is highest among the at least one performance indicator being extracted.

As described above, the present invention has been described using the above-described example embodiments as typical examples. However, the present invention is not limited to the above-described example embodiments. In other words, the present invention is applicable with various forms understood by those skilled in the art without departing from the scope of the present invention.

This application is based upon and claims the benefit of priority from Japanese patent application No. 2015-167943, filed on Aug. 27, 2015, the disclosure of which is incorporated herein in its entirety by reference.

### REFERENCE SIGNS LIST

10 Data processing apparatus
101 Processor
102 Memory
103 Storage
104 Display device
105 Input device
110 Guide-word extraction unit
120 Guide-word selection unit
130 Performance indicator extraction unit
140 Performance indicator selection unit
150 Model update unit
160 Associated node information storage unit
170 Synonym dictionary storage unit
180 Guide-word history storage unit
190 Performance indicator history storage unit

What is claimed is:

1. (canceled)

2. (canceled)

3. (canceled)

4. (canceled)

5. (canceled)

6. (canceled)

7. (canceled)

8. (canceled)

9. (canceled)

10. (canceled)

11. A data processing apparatus comprising:
processing circuitry and a storage storing data used by the processing circuitry, the processing circuitry being configured to form:
a guide-word extraction unit that extracts, based on a name of a first node that is a node included in a social system model, at least one guide-word corresponding to the first node from a guide-word storage that stores correspondence between a name of a node and a guide-word;
a guide-word selection unit that accepts selection input for at least one extracted guide-word;
a performance indicator extraction unit that extracts, from a performance indicator storage that stores correspondence between a guide-word and at least one performance indicator regarding an information communication system, at least one performance indicator corresponding to a selected guide-word;
a performance indicator selection unit that accepts selection input for at least one extracted performance indicator; and
a model update unit that associates, as a second node, a selected performance indicator with the first node.

12. The data processing apparatus according to claim 11, wherein the processing circuitry is further configured to form:
a node selection unit that accepts selection input of the first node, wherein
the guide-word extraction unit extracts a guide-word corresponding to a selected first node.

13. The data processing apparatus according to claim 11, wherein
the guide-word extraction unit
identifies, from a synonym dictionary storage that stores a name of a node stored on the guide-word storage and a term similar to the name of the node in association with each other, a name of a node similar to a name of the first node when a guide-word corresponding to the first node is not stored on the guide-word storage, and
extracts a guide-word corresponding to the first node from the guide-word storage, based on an identified name of the node.

14. The data processing apparatus according to claim 11, wherein
the guide-word extraction unit extracts, from a guide-word history storage that stores a guide-word selected in a past time and a name of a first node used as a basis for extracting the guide-word in association with each other, a guide-word corresponding to the first node, based on a name of the first node.

15. The data processing apparatus according to claim 11, wherein
the performance indicator extraction unit extracts, from a performance indicator history storage that stores a performance indicator, selected in a past time, of the information communication system and a combination of a node and a guide-word used as a basis for extracting the performance indictor in association with each other, a performance indicator corresponding to the selected node.

16. The data processing apparatus according to claim 11, wherein
the guide-word extraction unit assigns, by using a synonym dictionary storage that stores a name of a node stored on the guide-word storage and a term similar to the name of the node in association with each other, or a guide-word history storage that stores a guide-word selected in a past time and a name of a first node used as a basis for extracting the guide-word in association with each other, a score to each extracted guide-word.

17. The data processing apparatus according to claim 11, wherein
the performance indicator extraction unit assigns, by using a performance indicator history storage that stores a performance indicator, selected in a past time, of the information communication system and a combination of a node and a guide-word used as a basis for extracting the performance indicator in association with each other, a score to each extracted performance indicator.

18. The data processing apparatus according to claim 16, wherein
the guide-word selection unit selects a guide-word on which the score is highest among the extracted guide-words.

19. A data processing method for causing
a computer to execute processing of:
extracting, based on a name of a first node that is a node included in a social system model, at least one guide-word corresponding to the first node from a guide-word storage that stores correspondence between a name of a node and a guide-word;
accepting selection input for at least one extracted guide-word;
extracting, from performance indicator storage for storing correspondence between a guide-word and at least one performance indicator regarding an information communication system, at least one performance indicator corresponding to a selected guide-word;
accepting selection input for at least one extracted performance indicator; and
associating, as a second node, a selected performance indicator with the first node.

20. A non-transitory computer-readable storage medium stores a program causing a computer to function as:
a guide-word extraction unit that extracts, based on a name of a first node that is a node included in a social system model, at least one guide-word corresponding to the first node from a guide-word storage that stores correspondence between a name of a node and a guide-word;
a guide-word selection unit that accepts selection input for at least one extracted guide-word;
a performance indicator extraction unit that extracts, from a performance indicator storage that stores correspondence between a guide-word and at least one performance indicator regarding an information communication system, at least one performance indicator corresponding to a selected guide-word;
a performance indicator selection unit that accepts selection input for at least one extracted performance indicator; and
a model update unit that associates, as a second node, a selected performance indicator with the first node.
